(19) United States
(12) Patent Application Publication
(10) Pub. No.: US 2026/0332938 A1
(43) Pub. Date: Oct. 22, 2026

(54) HARDWARE GENERATED NOISE REDUCTION SYSTEM

(71) Applicant: Logitech Europe S.A., Lausanne (CH)

(72) Inventors: Milos CERNAK, Martigny (CH); Gregory FRANC DE FERRIERE, Ap Lei Chau (HK); Poornima NARASIMHAN, Tamil Nadu (IN); Kiril Daniel RATMANSKI, Sunnyvale, CA (US)

(21) Appl. No.: 19/183,349

(22) Filed: Apr. 18, 2025

(51) Int. Cl. H04R 1/10

(52) U.S. Cl. CPC H04R 1/1083

(57) ABSTRACT

Embodiments of the disclosure include an apparatus and method that are configured to determine, by a first electronic device in a first location, that a peripheral device is present within the first location; capture, by an audio system within the first location, audio data; select, by an algorithm, based on the determined presence of the peripheral device, a model that when executed is configured to suppress a portion of the audio data generated by the peripheral device; and generate, by a first audio processing device, denoised audio data by suppressing at least a portion of the portion of the audio data generated by the peripheral device by executing the selected model.

### BACKGROUND

### Field

Embodiments of the present disclosure generally relate to an audio device that includes a noise cancelling algorithm and process. In particular, embodiments disclosed herein relate to an algorithm that can suppress noise that is found in an audible signal that is to be transmitted to an electronic device positioned in a local or distant location.

### Description of the Related Art

On a daily basis, people on video conference calls, live streaming events, or phone calls with at least one other person are subjected to background noise that can be disruptive and impact the quality of the conversation between the people on these calls or events. Background noise can be disruptive to a user on both ends of a video conference call, live streaming event, or phone call. For example, a first user in a first location is on a call with a second user in a second location. Noise, generated by a peripheral device located in the first location like clicking from a keyboard, clicking or scrolling of a mouse, or the like can be distracting to users on at least the opposing end and/or both ends of the call. From the perspective of the first user, peripheral noise picked by a microphone in the first location can be undesirably delivered to the second user.

Thus, there is a need for an audio device that can suppress noise caused by peripheral devices in the first location from an audible signal provided to the second user.

### SUMMARY

Embodiments of the disclosure include a method comprising: determining, by a first electronic device in a first location, that a peripheral device is present within the first location; capturing, by an audio system within the first location, audio data; selecting, by an algorithm, based on the determined presence of the peripheral device, a model that when executed is configured to suppress a portion of the audio data generated by the peripheral device; and generating, by a first audio processing device, denoised audio data by suppressing at least a portion of the portion of the audio data generated by the peripheral device by executing the selected model. The process of determining that the peripheral device is present within the first location can be performed by detecting that the first electronic device and the peripheral device are in communication, a communication received from a second electronic device, or accessing metadata stored in memory. In some configurations, the algorithm is located in a memory of the audio system or the memory of the first electronic device.

Embodiments of the disclosure include a method comprising: capturing, by an audio system located in a first location, audio data; selecting, an algorithm located in the audio system, a model from a set of models that when executed is configured to suppress a portion of the audio data that is generated by a peripheral device that is located at the first location; generating, by the audio system, denoised audio data by suppressing at last a portion of audio data generated by the peripheral device from the audio data generated in the first location by executing the selected model; transmitting, by the audio system, the denoised audio data to a first electronic device; and transmitting, by the first electronic device, the denoised audio data to a second electronic device located in a second location.

Embodiments of the disclosure include a communication system comprising: a first electronic device in a first location configured to determine at least one peripheral device within the first location in communication with the first electronic device; an audio system within the first location configured to capture audio data generated within the first location; and an algorithm configured to select, based on the at least one peripheral device in communication with the first electronic device, a model that when executed is configured to suppress an attribute of audio data generated by the at least one peripheral device; and a first audio processing device configured to generate denoised audio data by suppressing audio generated by the at least one peripheral device from the audio data captured within the first location by executing the selected model.

Embodiments of the disclosure include a method comprising: selecting, by an algorithm located in a network that is in communication with a first electronic device, a model that when executed is configured to suppress noise generated by a peripheral device that is contained within audio data; transmitting, by the algorithm, communication data to the first electronic device; generating, by the first electronic device, denoised audio data by suppressing the noise generated by the peripheral device within the audio data by executing the selected model based on the communication data; and transmitting, by the first electronic device, the denoised audio data to the network. The communication data can include the selected model or an indication of the selected model.

Embodiments of the disclosure include a method comprising: selecting, by an algorithm located in a first electronic device, a model that when executed is configured to suppress a portion of audio data generated by a peripheral device that is contained within audio data generated in a first location; transmitting, by the first electronic device, communication data to an audio system; generating, by the audio system, denoised audio data by suppressing noise generated by the peripheral device from audio data generated in the first location by executing the selected model based on the communication data; transmitting, by the audio system, the denoised audio data to the first electronic device; and transmitting, by the first electronic device, the denoised audio data to a second electronic device located in a second location. The communication data can include the selected model or an indication of the selected model.

Embodiments of the disclosure include a method comprising: selecting, by an algorithm located in a first electronic device, a model that when executed is configured to suppress an attribute of audio data generated by a peripheral device connected to the first electronic device and located within a first location; generating, by the first electronic device, denoised audio data by suppressing noise generated by the peripheral device from audio data generated in the first location by executing the selected model; and transmitting, by the first electronic device, the denoised audio data to a second electronic device located in a second location.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A illustrates a conferencing environment that includes a communication system, according to one or more embodiments.

FIG. 1B illustrates a schematic view of an audio device, according to one or more embodiments.

FIG. 2 illustrates a method for suppressing noise generated by a peripheral device from an audible signal transmitted to a far end user using an algorithm located within the communication system, according to one or more embodiments.

FIG. 3 illustrates a method for suppressing noise generated by a peripheral device from an audible signal transmitted to a far end user using an algorithm located in the near end, according to one or more embodiments.

FIG. 4 illustrates a method for suppressing noise generated by a peripheral device from an audible signal transmitted to a far end user using an algorithm located in the near end, according to one or more embodiments.

FIG. 5 illustrates a method for suppressing noise generated by a peripheral device from an audible signal transmitted to a far end user using an algorithm located in a network, according to one or more embodiments.

FIG. 6 illustrates a method for suppressing noise generated by a peripheral device from an audible signal transmitted to a far end user using an algorithm located in the far end, according to one or more embodiments.

FIG. 7 illustrates a method for suppressing noise generated by a peripheral device from an audible signal transmitted to a far end user using an algorithm located in the far end, according to one or more embodiments.

FIG. 8A illustrates a frequency spectrum plot of an audible signal received by an electronic device or an audio device, according to one or more embodiments.

FIG. 8B illustrates frequency spectrums for sound generated by different types of peripheral devices that can be used within one or more models, according to one or more embodiments.

FIG. 8C illustrates a denoised frequency spectrum plot of denoised audio data that is generated based on the noise suppression activities performed on the audible signal shown in FIG. 8A, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Noise present during a video conference call, live streaming event, meeting, or phone call can be disruptive and impact the quality of the conversation between users that are present on the video conference, a streaming event, meeting, or call. For example, if a first user in a first location and a second user in a second location are on a call, noise caused by a peripheral device in the near end such as clicking of a mechanical keyboard, or scrolling from the mouse, or the like can be distracting to the users that are a part of the call. From the perspective of the second user, noise generated by a peripheral device that is captured by a microphone in the first location (i.e., the near end) may be delivered to an audio output of an audio device (such as headphones) used by the second user. The noise generated by peripheral devices in the first location may make it difficult for the second user to hear what the first user is communicating and/or may distract the second user.

One or more of the embodiments herein relate to an algorithm that can suppress noise generated from peripheral device(s) located in a first location from an audible signal provided to a user located in a second location.

### COMMUNICATION SYSTEM EXAMPLE

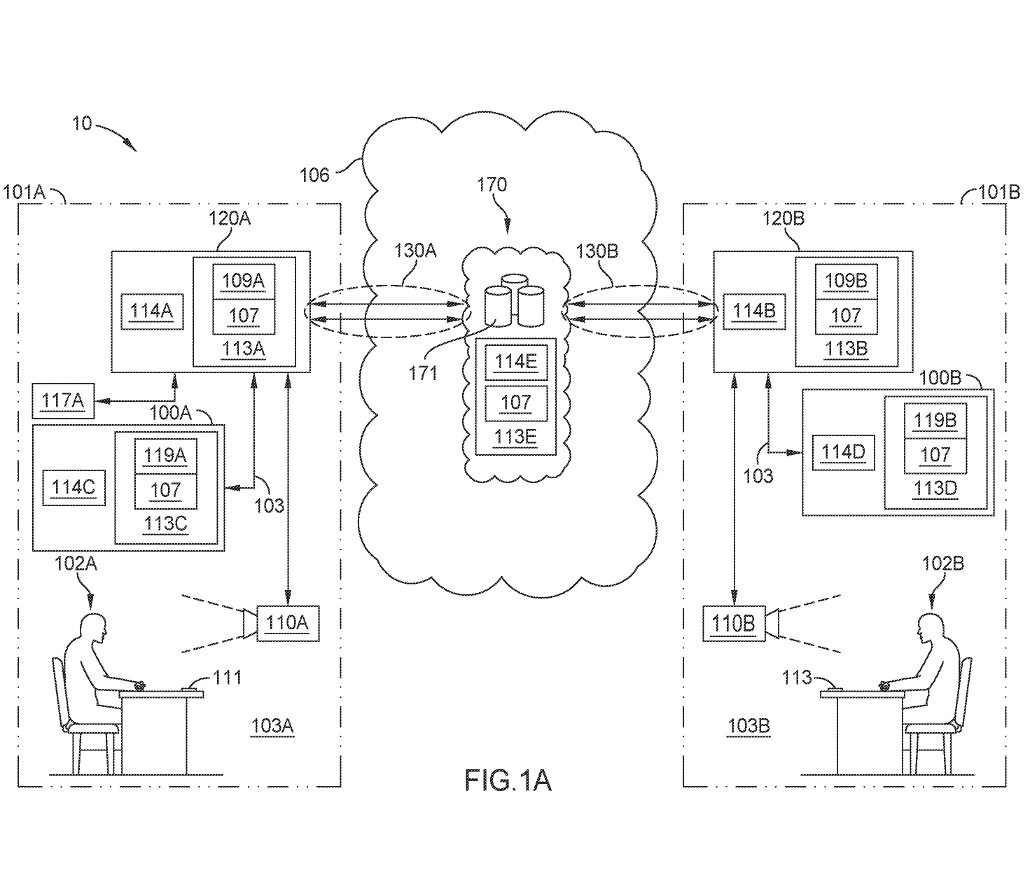

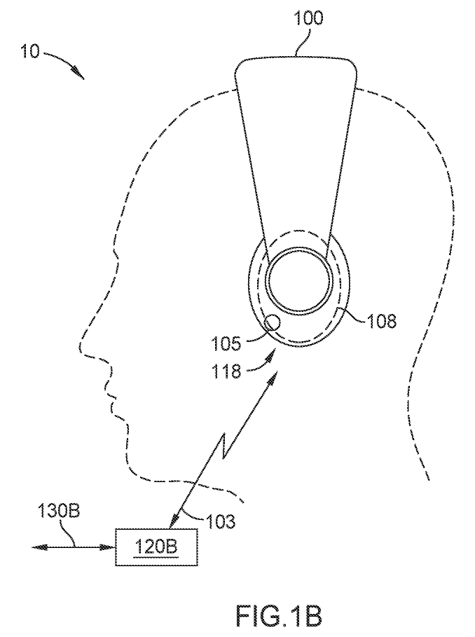

FIG. 1A is a diagram of a communication system, such as a conferencing calling system or simply a calling system 10, according to one or more embodiments. The calling system 10 includes a first location 101A and a second location 101B. The related equipment at each location 101A, 101B can include at least one microphone, at least one electronic device for providing the call stream to and from the locations 101A, 101B to the users, and at least one controlling device for handling the distribution of the different types of data exchanged between the locations 101A, 101B. In some cases, the calling system 10 can include one or more cameras, at least one microphone, at least one electronic device for providing the call stream to and from the locations 101A, 101B, and at least one controlling device for handling the distribution of the different types of data exchanged between the locations 101A, 101B. The related equipment for each location 101A, 101B is described in more detail below.

The second location 101B is at a location relative to the first location 101A. Stated differently, a first user 102A may be located in the first location 101A and a second user 102B may be located at the second location (or vice versa). For example, the second location 101B may include one or more locations that each include equipment used to facilitate the communication between users positioned at the various locations. Stated differently, the second location 101B may represent one or more locations occupied by one or more users. A location can be any location where it would not be feasible for a user at the location to communicate to another user without the use of an external device (e.g., an electronic device, such as a smart phone, tablet, laptop, microphone, etc.). The communication between the first user 102A (i.e., the first location 101A) and the second user 102B (i.e., the second location 101B) can be connected through a network 106. The network 106 generally represents any data communications network suitable for the transmission and receipt of audible signals and/or video data.

The calling system 10 enables the first user 102A and the second user 102B to receive audible information, such as verbal communications. For example, audio and/or video data can be exchanged through a communication software application 170 including but not limited to, Microsoft® Skype®, Microsoft® Teams®, Zoom®, Google® Hangouts®, a phone call app, a video game, streaming applications, or the like. The communication software application can include a communication node 171 to allow the first user 102A located at the first location 101A to communicate with the second user 102B located at the second location 101B. Although a first user 102A is in a first location 101A during a call with a second user 102B that is in a second location is described herein, this is only intended as an example, and any number of users in any number of locations can be communicating using the calling system 10. The electronic devices 120A, 120B can communicate with the communication node 171 of the communication software application 170 through corresponding first and second communication links 130A, 130B.

Optionally, auxiliary data can also be exchanged between the respective locations 101A, 101B through the communication software application 170 to further enhance the interaction between the users 102A, 102B. In some embodiments, the auxiliary data can be exchanged using a separate cloud service by use of a separate communication link. This auxiliary data can include any data exchanged between the locations 101A, 101B. For example, auxiliary data can include data related to instant messaging applications, screen sharing applications, or electronic document sharing applications.

The related equipment for the locations 101A, 101B can include audio devices, cameras, microphones, virtual reality (VR) devices, augmented reality (AR) devices, and display devices. For example, each location 101A, 101B includes various electronic devices. For example, the first location 101A includes one or more audio devices, such as one or more microphones 117A, and/or an audio device 100A. In one or more embodiments, the one or more microphones are included within the audio device 100A. The second location 101B can include one or more audio devices such as an audio device 100B. In one or more embodiments, the one or more microphones are included within the audio devices 100A, 100B. The audio devices 100A, 100B may be connected to a respective electronic device 120A, 120B (e.g., a laptop, personal computer, tablet, smart phone, television, etc.) by use of a communication link 103 that can be formed by use of a wired or wireless connection. Optionally, the locations 101A, 101B may include a camera device (e.g., video camera). For example, the first location 101A includes a camera device 110A, the one or more microphones 117A and/or the audio device 100A, and an electronic device 120A. The second location 101B includes a camera device 110B, the audio device 100B, and an electronic device 120B.

FIG. 1B illustrates a schematic view of an audio device 100, according to one or more embodiments. The audio device 100 corresponds to the audio device 100A and the audio device 100B. The audio device 100 may include headphones (a headset), a wired or wireless speaker, conference call device, or form a part of another type of audio producing device. It should be understood that in embodiments herein, the audio device 100 is described as headphones for example purposes only. The audio device 100 may be any suitable audio device. In one or more examples, the audio device 100 is able to connect to any suitable electronic device and switch connections between different audio devices mid-call. In one or more examples, a user, such as the first user 102A or the second user 102B can disconnect from a respective electronic device 120A, 120B to a mobile phone (not shown) mid-call without disrupting the conversation.

In one or more embodiments, the audio devices 100A, 100B may include an audio output device 108 (FIG. 1B), such as an audio speaker. The audio output device 108 may be coupled to a corresponding electronic device. For example the audio device 100A (FIG. 1A) is coupled to the electronic device 120A. The audio device 100B (FIG. 1A) is coupled to the electronic device 120B. In one or more embodiments, if the audio device 100 is a headphone, the audio output device 108 may be located in the earpieces 118.

In one or more embodiments, the audio device 100 may include one or more microphones 105. The one or more microphones 105 are configured to capture audio within a corresponding local environment in which the audio device 100 is positioned, and generate audio data based on the captured audio.

The one or more microphones 117A or the audio device 100A (e.g., the one or more microphones 105) can be used to capture audio in the first location 101A, such as the first user 102A’s voice and/or noise generated by the peripheral device 111, generate audio data based on the captured audio, and deliver the audio data to the audio output device 108 of the audio device 100B used by the second user 102B via the communication software application 170 including but not limited to, Microsoft® Skype®, Microsoft® Teams®, Zoom®, Google® Hangouts®, a phone call app, a video game or the like.

In one or more embodiments, the calling system 10 may be used in a call between the first user 102A and the second user 102B. It should be understood, that this is for example purposes only, and the call may include more than two users located in two or more locations. For example, purposes only, embodiments herein, will be described as an example of providing audio data captured in the first location 101 (e.g., from the first user 102A) to the second location 101B (e.g., to the second user 102B). Furthermore, embodiments herein will be described from the perspective of the first user 102A. The first location 101A is defined herein as the near end, and the second location 101B is defined herein as the far end from the perspective of the first user 102A. It is understood that the calling system 10 is also able to transmit audio data captured within the second location 101B to the first location 101A in the same manner described below.

As noted above, noise generated by a peripheral device, such as peripheral device 111, located on either side of a conference call can be disruptive to the participants. For example, clicking of a keyboard in the local environment (e.g., first location 101A) can make it challenging for the second user 102B to hear audio data transmitted from the first user 102A. Additionally, the noise generated by the peripheral device 111 in the first location 101A can make it difficult for the first user 102A wearing the audio device 100A to hear the second user 102B (or vice versa), and thus some of the denoising techniques described herein can be used to suppress at least a portion of the noise generated by the peripheral device received by the first user 102A. Embodiments herein, relate to a process and an algorithm that can suppress noise generated by peripheral device(s) captured on the near end. The algorithm 107 can be used to suppress noise generated by peripheral device(s) from audio data transmitted from one user to another user. Stated otherwise, the algorithm 107 can be used suppress the noise included in an audible signal transmitted to the second user 102B that is generated by the peripheral device 111 (or vice versa). More specifically, in some embodiments, the algorithm 107 is configured to suppress specific types of noise captured in the near end from being transmitted to the far end (e.g., the second user 102B).

In one or more embodiments, at least one of the locations 101A, 101B, and/or the network 106 include the algorithm 107. The algorithm 107 is operable to suppress (e.g., cancel out) noise generated by a peripheral device 111 (or any quantity of peripheral devices) that is connected to the electronic device 120A (located in the first location 101A). The peripheral device 111 may include, but is not limited to, a keyboard, a mouse, key pad, a speaker (wired or wireless), or the like, that generates a specific noise signature (e.g., sound spectrum) that is captured by the one or more microphones 117A and/or the audio device 100A, and included in the audio data that is transmitted to the second user 102B. For example, if the peripheral device 111 is a keyboard or a mouse, the algorithm 107 suppresses the clicking noise generated by typing on the keyboard or the clicking noise generated by clicking of the mouse. As another example, if the peripheral device 111 is a speaker, the algorithm 107 suppresses noise such as the speaker start up sound, a Bluetooth pairing notification sound, and voice status feedback, such as a low battery alert. Although one peripheral device 111 is illustrated in FIG. 1A, this is for example purposes only and any quantity of peripheral devices can be connected to the electronic device 120A. As will be described in more detail below, the algorithm 107 can be located in the electronic device 120A, the audio device 100A, the network 106, or combinations thereof. As will be described in more detail below, the algorithm 107 is configured to receive metadata and select a model from sets of models that are used to suppress the noise generated by the peripheral device 111 (or any other peripheral device located in the first location).

In one or more embodiments, the electronic device 120A includes a controller 114A and a memory 113A. The controller 114A may be a processor that analyzes information and carries out a series of executable scripts, e.g., stored in the memory 113A. In one or more embodiments, the controller 114A may comprise an application-specific integrated circuit (ASIC) device, a system on chip (SOC), or any other processing unit known in the art. The memory 113A may be programmed for short term and/or long term memory storage. The memory 113A may include both volatile and non-volatile memories.

The memory 113A may store an audio generation software application 109A that may be used in conjunction with the controller 114A. The audio generation software application 109A receives audio data captured by the one or more microphones 117A and/or the audio device 100A and performs processing on audio data.

In one or more embodiments, the audio device 100A includes a controller 114C and a memory 113C. The controller 114C may be a processor that analyzes information and carries out a series of executable scripts, e.g., stored in the memory 113A. In one or more embodiments, the controller 114C may comprise an application-specific integrated circuit (ASIC) device, a system on chip (SOC), or any other processing unit known in the art. The memory 113C may be programmed for short term and/or long term memory storage. The memory 113C may include both volatile and non-volatile memories. The memory 113C may include a program 119A that when executed by the controller 114C causes the controller 114C to perform processing (pre-processing and/or post-processing) on audio data.

In one or more embodiments, the electronic device 120B includes a controller 114B and a memory 113B. The controller 114B may be a processor that analyzes information and carries out a series of executable scripts, e.g., stored in the memory 113B. In one or more embodiments, the controller 114B may comprise an application-specific integrated circuit (ASIC) device, a system on chip (SOC), or any other processing unit known in the art. The memory 113B may be programmed for short term and/or long term memory storage. The memory 113B may include both volatile and non-volatile memories.

The memory 113B may store an audio generation software application 109B that may be used in conjunction with the controller 114B. The audio generation software application 109B and the audio generation software application 109A may be the same audio generation software applications. The audio generation software application 109B receives the audio data transmitted via the network 106 and processes the received audio data. In one or more embodiments, processing the audio data includes generating and providing an audible signal to the second user 102B. The processing of the audio data by the audio devices 100A, 100B and the electronic devices 120A, 120B are described in more detail below.

In one or more embodiments, the audio device 100B includes a controller 114D and a memory 113D. The controller 114D may be a processor that analyzes information and carries out a series of executable scripts, e.g., stored in the memory 113D. In one or more embodiments, the controller 114D may comprise an application-specific integrated circuit (ASIC) device, a system on chip (SOC), or any other processing unit known in the art. The memory 113D may be programmed for short term and/or long term memory storage. The memory 113D may include both volatile and non-volatile memories. The memory 113D may further include a program 119B that when executed by the controller 114D causes the controller 114D to perform processing (pre-processing and/or post-processing) on audio data.

In one or more embodiments, the communication software application 170 further includes a server 114E and a memory 113E. The server 114E is configured to analyze information and carry out a series of executable scripts, e.g., stored in the memory 113E. The memory 113E may be programmed for short term and/or long term memory storage. The memory 113E may include both volatile and non-volatile memories.

In one or more embodiments, the algorithm 107 may be stored in the first location 101A, the second location 101B, the communication software application 170, and combinations thereof. When the algorithm 107 is stored in multiple locations, processing can be split between the algorithm 107 located in the location(s) and the algorithm 107 located in the communication software application 170.

The algorithm 107 can further be stored in a single or multiple locations within each location. As illustrated in FIG. 1A, the algorithm 107 can be stored in any combination of the following locations: the audio generation software application 109A (the electronic device 120A), the memory 113C (the audio device 100A), the audio generation software application 109B (the electronic device 120B), the memory 113D (the audio device 100D), and/or the memory 113E (the communication software application 170).

In one or more examples, executable models that are used to suppress noise caused by the peripheral device 111 (or any other peripheral device(s)) located in the first location 101A) can be further stored in the memory 113A, the memory 113B, the memory 113C, the memory 113D, and/or the memory 113E. Each of the models can be configured to include attributes that relate to a noise spectrum generated by a type of peripheral device. For example, a set of models corresponds to different types of keyboards, another set of models correspond to different types of mice, and so on. The models within each of the sets of models range from general models used to generally describe many different types of devices (e.g., multiple keyboards) to models that describe a specific model of a device (e.g., a specific keyboard). For example, the set of models that are configured to suppress noise generated by a keyboard includes, but is not limited to, a general model used to suppress noise generated by any style of keyboard, a device class type model used to suppress noise generated by any mechanical keyboard, any membrane keyboard, or the type of switches used on various mechanical keyboards (e.g., linear, tactile, and clicky switches keyboards), and a specific device model that is used to suppress noise generated by specific keyboard model or part number.

The algorithm 107 receives metadata which includes information regarding the specific type, the model number, or the specific type and model number of the peripheral device 111 (plus any other peripheral devices) connected to the electronic device 120A. In some embodiments, the metadata includes audible characteristics and/or the specific model that relates to one or more peripheral devices. The audible characteristics can include specific characteristics of the peripheral device 111 such as sound pressure level (SPL) and/or characteristic noise frequencies (e.g., frequencies commonly found in an audible signal provided from a noise source) and temporal characteristics which determine whether the noise generated by the peripheral device 111 is constant or dynamic (e.g., temporal sounds such as a fan running or dynamic sounds such keyboard key clicks). In one or more embodiments, the characteristics noise frequencies that can be detected and used to denoise the noise generated by one or more peripheral devices include magnitude and phase of the frequencies received in the noise spectrum.

Based on the metadata, the algorithm 107 selects at least one model to suppress the noise generated by the peripheral device 111 that is contained within a received audible signal, such as a signal received within a local location. The noise generated by the peripheral device 111 can be suppressed by at least one audio processing device of the calling system 10 (e.g., at least one of the audio device 100A, the audio device 100B, the electronic device 120A, the electronic device 120B, and/or the communication software application 170) regardless of the location of the algorithm 107. The peripheral noise can be suppressed by the device in which the algorithm 107 is located or any other audio processing device within the calling system 10. For example, if the algorithm 107 is located within the audio device 100A, the algorithm 107 can inform the controller 114C of the selected model, and the controller 114C can execute the selected model to suppress the noise generated by the peripheral device 111. As another example, if the algorithm 107 is located within the audio device 100A, the algorithm 107 can inform the controller 114C of the selected model, and the selected model can be transmitted from the memory 113C to a different controller that executes the selected model to suppress the noise generated by the peripheral device 111. As another example, if the algorithm 107 is located within the audio device 100A, the algorithm 107 can inform the controller 114C of the selected model, and the controller 114C can inform a controller located in a different device in the calling system 10 that includes the selected model. This will be described in more detail below.

Furthermore, the algorithm 107 can be used to select a model that additionally suppresses noise generated within an audible signal(s) received from a location (or user). For example, the algorithm 107 can be used to further suppress noise generated from a peripheral device 113 located in the second location 101B. Stated differently, the algorithm 107 can selected a model that can also be used to suppress noise generated from the peripheral device 111 and/or suppress noise generated by the peripheral device 113 from an audible signal transmitted from the second user 102B (or vice versa).

In one or more embodiments, the algorithm 107 may be an artificial intelligence (AI) algorithm to detect and suppress noise generated by peripheral device(s) (e.g., peripheral device 111). Furthermore, each model within the sets of models of the algorithm are AI models. In general, an AI algorithm (and AI models) will include processes that require combining large sets of data with intelligent, iterative processing algorithms to learn from patterns and features in the data (e.g., audio data) that it has analyzed and/or is analyzing. Each time an AI algorithm (and AI model) runs a round of data processing, it will test and measure its own performance so as to develop additional expertise based on the performance of these activities. In this case, the algorithm 107 is used to generate and improve the selection of an AI model to suppress sudden noise generated by peripheral device(s) and improve the noise suppression activities performed by the AI models based on received prior and current data. In some embodiments, the training performed on the AI model includes the use of audio data that describes specific audible characteristics of a plurality of devices that are to be excluded or suppressed during noise suppression activities (e.g., denoising process). The specific characteristics can include a sound pressure level (SPL) and/or characteristic noise frequencies (e.g., frequencies commonly found in an audible signal provided from a noise source (e.g., keyboard key click)).

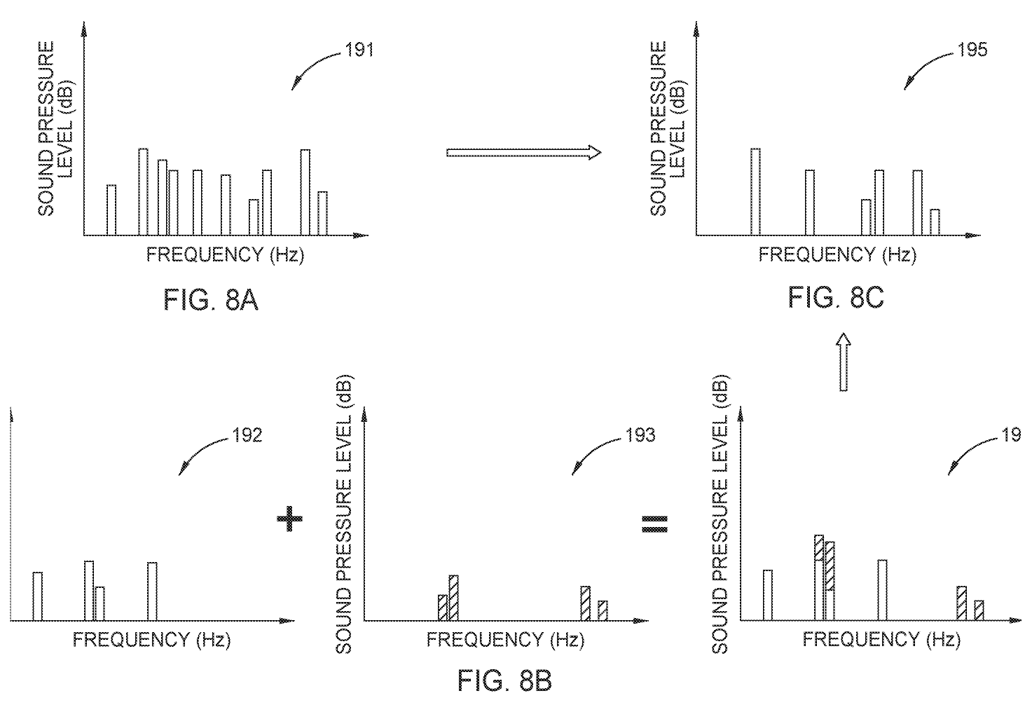

As will discussed further below, during one or more of the processes of suppressing noise(s) generated by a peripheral device, audio data (or preprocessed audio data) is received by an audio system, wherein the audio data has a frequency spectrum 191. As shown in FIG. 8A, the audio data, which for discussion purposes is illustrated as quantized frequency peaks (i.e., 10 frequency spectrum peaks) that are intended to illustrate the frequency spectrum 191 of the raw audio data. In this example, the audio data includes desirable audio data and noise generated by at least one peripheral device. FIG. 8B illustrates attributes of frequency spectrums for sound generated by different types of peripheral devices that can be used within one or more models during a noise suppression process. In this example, a first model has been developed to account for a frequency spectrum of a first peripheral device that has a representative first frequency spectrum 192. A second model includes a frequency spectrum for a second peripheral device that has a representative second frequency spectrum 193. In some embodiments, if the first and second peripheral devices include the same type of peripheral device, such as both are different types or models of mechanical keyboards, a third model that has a third frequency spectrum 194 can be created by combining the frequency spectrums of at least two frequency spectrums of the same type of peripheral devices. In some cases, the third type of model can be used as a device class type model or even as general model during the noise suppression activity. However, the device class type model or even a general model are not limited to models that are formed by a combination of specific device models, and can include more generalized or simplified frequency spectrums that have been developed and/or adjusted to better represent a larger number of similar peripheral devices within a genus, class or species of peripheral devices. As noted above and below, in some embodiments, a noise suppression activity can include using one or more models to remove or suppress at least portion of audible signal to form a denoised audible signal that is then transferred to a far end user. The one or more models are thus configured to remove or suppress an attribute of the noise that is found within the raw audio data. As shown in FIG. 8C, a noise suppression activity can include applying a model, such as the third model to the originally received audible signal to form denoised audio data that has a denoised frequency spectrum 195. Forming the denoised audio data can be completed by subtracting the third frequency spectrum 194 from the frequency spectrum 191 of the original audio data to form the denoised frequency spectrum 195. In one or more embodiments, the noise suppression techniques can be performed in the time domain by use of bandpass filters, equalizers, automatic gain control (AGC), or dynamic range compression, or combinations thereof, which can be important to resolve constant and dynamic generated noise.

### Methods for Suppressing Noise Generated by a Peripheral Device

### First Noise Suppression Methd Example

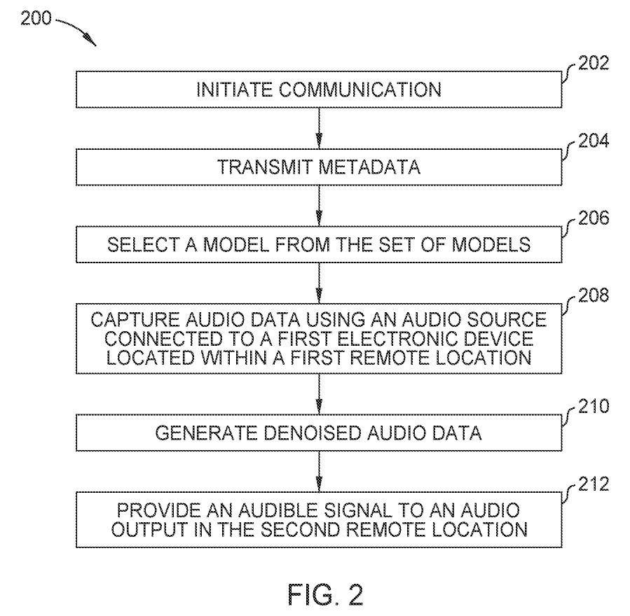

FIG. 2 illustrates a method 200 for suppressing noise generated by a peripheral device from an audible signal transmitted to a far end user using an algorithm located within the calling system 10. FIG. 2 is described with reference to FIGS. 1A-1B. Although the method 200 is described with respect to a single peripheral device 111 connected to the electronic device 120A (a first electronic device), this is for example purposes only. It is understood that multiple peripheral devices can be connected to the electronic device 120A.

At operation 202 of the method 200, communication is initiated. In one or more embodiments, communication is a call between at least two users. As noted above, the call between the first two users may be performed using a communication software application 170. In addition, as noted above, the communication is from the perspective of a first user 102A, which is located in the first location 101A, on a call with the second user 102B, which is located in the second location 101B. In other embodiments, communication is initiated by the first user 102A and can be recorded by the audio generation software application 109A and saved to the memory 113A.

At operation 204 of the method 200, the algorithm 107 retrieves metadata from memory or receives metadata transmitted to it from the electronic device 120A. In one or more embodiments, the metadata is generated and transmitted to the algorithm 107 by the electronic device 120A. In another embodiment, the metadata is generated by the electronic device 120A, is stored in the memory 113A, and the algorithm 107 accesses the metadata from the memory 113A. The metadata is used to inform the algorithm 107 of the type and/or model number of the peripheral device 111 that is connected to the electronic device 120A located within the first location 101A. In one or more embodiments, the metadata further includes information such as the type and/or model number, the processing power, the memory size (or available memory) and the battery capacity (of available battery), or the like of the audio processing device within the calling system 10 that will execute the model selected by algorithm 107. This will be described in more detail below.

Because the peripheral device 111 is connected to the electronic device 120A, the controller 114A is able to determine and provide information regarding a specific model number(s) of the peripheral device(s) in communication with the electronic device 120A. For example, the controller 114A is able to provide the audio generation software application 109A with information relating to the specific model number of the peripheral device 111. The metadata is then transmitted to the algorithm 107 by the audio generation software application 109A.

As noted above, the algorithm 107 may be located in at least one (i.e., any combination of) of the audio device 100A, the electronic device 120A, the network 106, the audio device 100B, the electronic device 120B, and the audio device 100B. If the algorithm 107 is located within the audio device 100A, the metadata can transmitted from the audio generation software application 109A to the algorithm 107 located in the memory 113C by use of the communication link 103. If the algorithm 107 is located within the electronic device 120A (memory 113A), the metadata can transmitted from the audio generation software application 109A to the algorithm 107. If the algorithm 107 is located within the network 106 (the memory 113E of the communication software application 170), the metadata can transmitted from audio generation software application 109A to the algorithm 107 by use of the first communication links 130A. If the algorithm 107 is located within the electronic device 120B (the memory 113B), the metadata can transmitted from audio generation software application 109A to the network 106 by use of the first communication links 130A, and from the network 106 to the algorithm 107 by use of the second communication links 130B. If the algorithm 107 is located within the audio device 100B (the memory 113D), the metadata can transmitted from audio generation software application 109A to the network 106 by use of the first communication link 130A, and from the network 106 to the second electronic device 120B (the audio generation software application 109B) by use of the second communication link 130B, and from the audio generation software application 109A to the algorithm 107 by use of the of the communication link 103. As noted above, the algorithm 107 can be located within any of audio processing device within the calling system 10 and the metadata can be sent to multiple devices within the communication system using the communication paths described above.

At operation 206 of the method 200, the algorithm 107 selects a model from the sets of models based on the information contained within the metadata. As noted above, the metadata received by the algorithm 107 includes information relating to the specific model number of the peripheral device 111 and/or information relating to the specific audio processing device (such as make and model) in the calling system 10 that will perform the suppression of the noise generated by the peripheral device 111. For example, if the peripheral device 111 is a mechanical keyboard, the metadata includes information relating to the manufacturer and model number of the keyboard. The algorithm 107can then select a model from the set of models that correspond to a keyboard and/or can be executed by the audio processing device of the calling system 10 that will perform the suppression of the noise generated by the peripheral device 111 (i.e., performs denoising by executing the selected model).

As noted above, the selected model can be executed by an audio processing device such as the audio device 100A, the audio device 100B, the electronic device 120A, the electronic device 120B, the communication software application 170, or combinations thereof regardless of the location of the algorithm 107.

In one or more embodiments, selecting a model from the set of models includes the algorithm 107 selecting a model based on the metadata and transmitting communication data that includes at least one of the selected model and/or an indication of the selected model. The communication data is transmitted internally in the device (from the algorithm 107 to a controller within the same device) or between devices.

In one or more embodiments, if the selected model is to be executed on the audio device 100A, the algorithm 107 selects the model based on the information relating to manufacturer and model number of the peripheral device 111, the processing power required to execute each model within the set of models, the memory consumed by each model, the battery consumption required to execute each model within the set of models, and the like versus the processing power, memory capacity, and battery capacity of the audio device 100A. For example, a model within the set of models might require more processing power than the processing power of the controller 114C, more memory than what is available in the memory 113C, and/or consume a substantial quantity of battery life (e.g., based on the battery capacity of the audio device 100A, the remaining battery, and/or if the audio device 100A is in power saving mode). Stated otherwise, in some embodiments, the algorithm 107 selects the most specific model that is within at least the processing capabilities of the controller 114C, the memory capacity of the memory 113C, and battery capacity (and requirements) of the audio device 100A. Then the selected model is transmitted by the electronic device 120A (the audio generation software application 109A) to the audio device 100A (the memory 113C).

If the selected model is to be executed by the electronic device 120A, the algorithm 107 selects a model based on, for example, information relating to the manufacturer and model number of the peripheral device 111, the processing power required to execute each model within the set of models, the battery consumption required to execute each model within the set of models, and the like versus the processing power, the memory capacity, and the battery capacity of the electronic device 120A. As noted above, the algorithm 107 can select a model corresponding to, but not limited to, a general keyboard model, any type of mechanical keyboard model, a mechanical keyboard with a specific type of switches model, or the specific model number of the peripheral device 111 model. For example, a model within the set of models might require more processing power than the available processing power of the controller 114A, and/or consume a substantial quantity of battery life (e.g., based on the battery capacity of the electronic device 120A, the remaining battery, and/or if the electronic device is in power saving mode). Stated otherwise, in some embodiments, the algorithm 107 selects the most specific model that is within at least the processing capabilities of the controller 114A and battery capacity (and requirements) of the electronic device 120A.

If the selected model is to be executed by the communication software application 170 (by the server 114E), the algorithm 107 selects the model based on the information relating to manufacturer and model number of the peripheral device 111, the processing power required to execute each model within the set of models, the memory consumed by each model, and the like versus the processing power and memory capacity, of the communication software application 170. For example, a model within the set of models might require more processing power than the processing power of the server 114E, and/or more memory than what is available in the memory 113E. Stated otherwise, in some embodiments, the algorithm 107 selects the most specific model that is within at least the processing capabilities of the communication software application 170.

If the selected model is to be executed by the electronic device 120B, the algorithm 107 selects a model based on, for example, information relating to the manufacturer and model number of the peripheral device 111, the processing power required to execute each model within the set of models, the battery consumption required to execute each model within the set of models, and the like versus the processing power, the memory capacity, and the battery capacity of the electronic device 120B. As noted above, the algorithm 107 can select a model corresponding to, but not limited to, a general keyboard model, any type of mechanical keyboard model, a mechanical keyboard with a specific type of switches model, or the specific model number of the peripheral device 111 model. For example, a model within the set of models might require more processing power than the available processing power of the controller 114B, and/or consume a substantial quantity of battery life (e.g., based on the battery capacity of the electronic device 120B, the remaining battery, and/or if the electronic device is in power saving mode). Stated otherwise, in some embodiments, the algorithm 107 selects the most specific model that is within at least the processing capabilities of the controller 114B and battery capacity (and requirements) of the electronic device 120B.

In one or more embodiments, if the selected model is to be executed on the audio device 100B, the algorithm 107 selects the model based on the information relating to manufacturer and model number of the peripheral device 111, the processing power required to execute each model within the set of models, the memory consumed by each model, the battery consumption required to execute each model within the set of models, and the like versus the processing power, memory capacity, and battery capacity of the audio device 100B. For example, a model within the set of models might require more processing power than the processing power of the controller 114D, more memory than what is available in the memory 113D, and/or consume a substantial quantity of battery (e.g., based on the battery capacity of the audio device 100B, the remaining battery, and/or if the audio device 100A is in power saving mode). Stated otherwise, in some embodiments, the algorithm 107 selects the most specific model that is within at least the processing capabilities of the controller 114D, the memory capacity of the memory 113D, and battery capacity (and requirements) of the audio device 100B.

As noted above, the communication data is sent to the device(s) that are going to execute the selected model. If the algorithm 107 is located in the audio device 100A (the memory 113C) the selected model can be executed by the audio device 100A and/or at least one of: the electronic device 120A, the network 106, the electronic device 120B, and/or the audio device 100B. If the selected model is executed in a device different from the audio device 100A, the communication data can be sent to the electronic device 120A, the network 106, the electronic device 120B, and/or the audio device 100B. If the selected model is to be executed by the audio device 100A, the algorithm 107 transmits the communication data to the controller 114C.

If the algorithm 107 is located in the electronic device 120A (the memory 113A) the selected model can be executed by the electronic device 120A and/or at least one of: the audio device 100A, the network 106, the electronic device 120B, and/or the audio device 100B. If the selected model is executed in a device different from the electronic device 120A, the communication data can be sent to the audio device 100A, the network 106, the electronic device 120B, and/or the audio device 100B. If the selected model is to be executed by the electronic device 120A, the algorithm 107 transmits the communication data to the controller 114A.

If the algorithm 107 is located in the network 106 (the memory 113E of the communication software application 170) the selected model can be executed by the communication software application 170, and/or at least one of: the audio device 100A, the electronic device 120A, the electronic device 120B, and/or the audio device 100B. If the selected model is executed in a device different from the network 106, the communication data can be sent to the audio device 100A, the electronic device 120B, the electronic device 120B, and/or the audio device 100B. If the selected model is to be executed by the network 106, the algorithm 107 transmits the communication data to the server 114E.

If the algorithm 107 is located in the electronic device 120B (the memory 113B) the selected model can be executed by the electronic device 120B and/or at least one of: the audio device 100A, the network 106, the electronic device 120A, and/or the audio device 100B. If the selected model is executed in a device different from the electronic device 120B, the communication data can be sent to the audio device 100A, the network 106, the electronic device 120A, and/or the audio device 100B. If the selected model is to be executed by the electronic device 120B, the algorithm 107 transmits the communication data to the controller 114B.

If the algorithm 107 is located in the audio device 100B (the memory 113D) the selected model can be executed by the audio device 100B and/or at least one of: the electronic device 120A, the network 106, the electronic device 120B, and/or the audio device 100A. If the selected model is executed in a device different from the audio device 100B, the communication data can be sent to the electronic device 120A, the network 106, the electronic device 120B, and/or the audio device 100A. If the selected model is to be executed by the audio device 100B, the algorithm 107 transmits the communication data to the controller 114D.

At operation 208 of the method 200, audio data generated in the first location 101A is captured using an audio system connected to the electronic device 120A located in the first location 101A. In one or more embodiments, the audio system includes the audio device 100A, and the audio data is captured by the one or more microphones 105 of the audio device 100A.

At operation 210 of the method 200, the noise generated by the peripheral device 111 is at least partially removed (i.e., suppressed) from the audio data to form denoised audio data (i.e., the audio data is denoised). In one or more embodiments, suppressing the noise generated by the peripheral device 111 includes the controller associated with the device that is going to execute the selected model applying and executing the selected model. If the communication data includes an indication of the selected model, the controller associated with the device fetches the model from memory. If the communication data includes the selected model itself, the controller associated with the device executes the received model. In one or more embodiments, selected model, when executed, suppresses the noise generated by the peripheral device 111 by removing an attribute of the noise generated by the peripheral device 111 from the audio data such as the clicking sound from a keyboard.

If the audio device 100A is performing the denoising of the audio data, the controller 114C, based on the received communication data, applies and executes the selected model. If the communication data includes the selected model, the controller 114C applies and executes the received selected model. If the communication data includes an indication of the selected model, the controller 114C fetches the selected model from the memory 113C and then applies and executes the received selected model.

If the electronic device 120A is performing the denoising of the audio data, the controller 114A, based on the received communication data, applies and executes the selected model. If the communication data includes the selected model, the controller 114A applies and executes the received selected model. If the communication data includes an indication of the selected model, the controller 114A fetches the selected model from the memory 113A and then applies and executes the received selected model.

If the network 106 is performing the denoising of the audio data, the server 114E, based on the received communication data, applies and executes the selected model. If the communication data includes the selected model, the server 114E applies and executes the received selected model. If the communication data includes an indication of the selected model, the server 114E fetches the selected model from the memory 113E and then applies and executes the received selected model.

If the electronic device 120B is performing the denoising of the audio data, the controller 114B, based on the received communication data, applies and executes the selected model. If the communication data includes the selected model, the controller 114B applies and executes the received selected model. If the communication data includes an indication of the selected model, the controller 114B fetches the selected model from the memory 113B and then applies and executes the received selected model.

If the audio device 100B is performing the denoising of the audio data, the controller 114D, based on the received communication data, applies and executes the selected model. If the communication data includes the selected model, the controller 114D applies and executes the received selected model. If the communication data includes an indication of the selected model, the controller 114D fetches the selected model from the memory 113D and then applies and executes the received selected model.

At operation 212 of the method 200, an audible signal is transmitted to an audio output in the second location 101B. In one or more embodiments, the audio generation software application 109B receives the post-processed audio data, generates an audible signal from the post-processed audio data, and transmits the audible signal to the audio output, such as the audio output device 108 of the audio device 100B. This will be described in more detail below.

### Second Noise Suppression Method Example

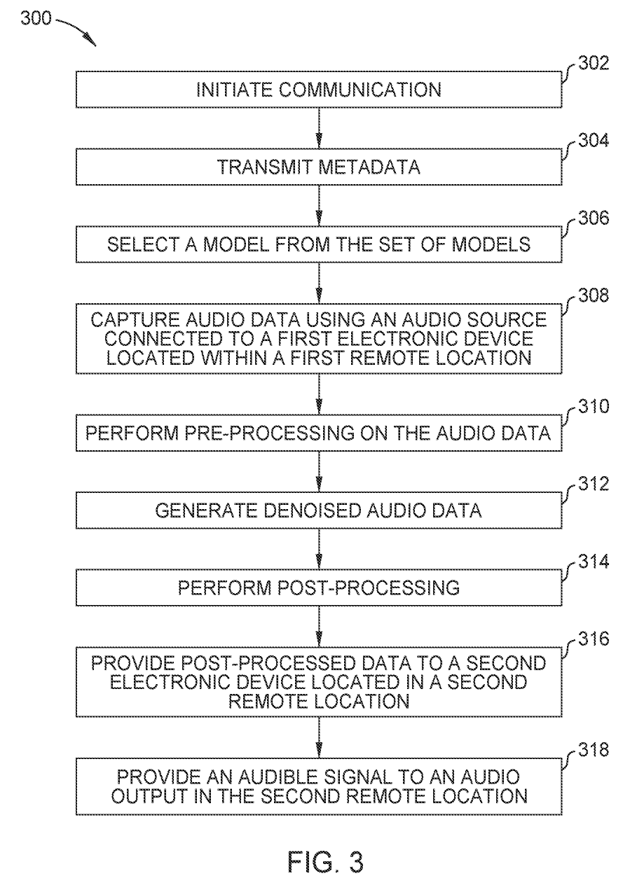

FIG. 3 illustrates a method 200 for suppressing noise generated by a peripheral device from an audible signal transmitted to a far end user within the near end using an algorithm located (stored) within the near end environment (e.g., first location 101A), according to one or more embodiments. FIG. 3 is described with reference to FIGS. 1A-1B. In one or more embodiments, during the method 300, the algorithm 107 is stored in the memory 113C. In one example, the memory 113C is disposed within the audio device 100A. Although the method 300 is described with respect to a single peripheral device 111 connected to the electronic device 120A (a first electronic device), this is for example purposes only. It is understood that multiple peripheral devices can be connected to the electronic device 120A.

At operation 302 of the method 200, In one or more embodiments, communication is a call between at least two users. As noted above, the call between the first two users may be performed using a communication software application 170. In addition, as noted above, the communication is from the perspective of a first user 102A, which is located in the first location 101A, on a call with the second user 102B, which is located in the second location 101B. In other embodiments, communication is initiated by the first user 102A and can be recorded by the audio generation software application 109A and saved to the memory 113A.

At operation 304 of the method 200, the algorithm 107 retrieves metadata from memory or receives metadata transmitted to it from the electronic device 120A. In one or more embodiments, the metadata is generated and transmitted to the algorithm 107 by the electronic device 120A. In another embodiment, the metadata is generated by the electronic device 120A, is stored in the memory 113A, and the algorithm 107 accesses the metadata from the memory 113A.

Because the peripheral device 111 is connected to the electronic device 120A, the controller 114A is able to provide information regarding a specific model number(s) of the peripheral device(s) in communication with the electronic device 120A to the audio generation software application 109A along with information regarding the device that will execute the selected model. For example, the controller 114A is able to provide the audio generation software application 109A with information relating to the specific model number of the peripheral device 111 along with information relating to the electronic device 120A (i.e., or any other devices located in the first location 101A (the near end)). If the selected model is going to be executed by the audio device 100A, the metadata is then transmitted to the algorithm 107 by the audio generation software application 109A by use of the communication link 103.

At operation 306 of the method 300, the algorithm 107 selects a model from the sets of models based on the information contained within the metadata. As noted above, the metadata received by the algorithm 107 includes information relating to the specific model number of the peripheral device 111 and/or information of the device that will execute the selected model. For example, if the peripheral device 111 is a mechanical keyboard, the metadata includes information relating to the manufacturer and model number of the keyboard. The algorithm 107 can then select a model from the set of models that correspond to a keyboard and generate the communication data based on the information within the metadata.

As noted above, if the model is to be executed within the audio device 100A (the device in which the algorithm 107 is located) the algorithm 107 selects the model (and provides the communication data to the controller 114C) based on the manufacturer and model number of the keyboard, the processing power required to execute each model within the set of models, the battery consumption required to execute each model within the set of models, and the like versus the processing power and the battery capacity of the audio device 100A. As noted above, the algorithm 107 can select and execute a model corresponding to, but not limited to, a general keyboard model, any type of mechanical keyboard model, a mechanical keyboard with a specific type of switches model, or the specific model number of the peripheral device 111 model. For example, a model within the set of models might require more processing power than the processing power of the controller 114C, and/or consume a substantial quantity of battery life (e.g., based on the battery capacity of the audio device 100A, the remaining battery, and/or if the audio device 100A is in power saving mode). Stated otherwise, in some embodiments, the algorithm 107 selects and executes the most specific model that is within at least the processing capabilities of the controller 114C, and battery capacity (and requirements) of the audio device 100A.

On the other hand, if the selected model is going to be executed by the electronic device 120A (or any other different device within the near end environment), the algorithm 107 generates the communication data based on the received metadata and transmits the communication data to the electronic device 120A. The algorithm 107 selects a model based on, for example, information relating to the manufacturer and model number of the peripheral device 111, the processing power required to execute each model within the set of models, the battery consumption required to execute each model within the set of models, and the like versus the processing power, the memory capacity, and the battery capacity of the electronic device 120A. As noted above, the algorithm 107 can select a model corresponding to, but not limited to, a general keyboard model, any type of mechanical keyboard model, a mechanical keyboard with a specific type of switches model, or the specific model number of the peripheral device 111 model. For example, a model within the set of models might require more processing power than the available processing power of the controller 114A, and/or consume a substantial quantity of battery life (e.g., based on the battery capacity of the electronic device 120A, the remaining battery, and/or if the electronic device is in power saving mode). Stated otherwise, in some embodiments, the algorithm 107 selects the most specific model that is within at least the processing capabilities of the controller 114A and battery capacity (and requirements) of the electronic device 120A.

At operation 308 of the method 300, audio data generated in the first location 101A is captured using an audio system connected to the electronic device 120A located in the first location 101A. In one or more embodiments, the audio system includes the audio device 100A, and the audio data is captured by the one or more microphones 105 of the audio device 100A.

At operation 310 of the method 300, pre-processing is performed on the audio data to generate pre-processed audio data. In one or more embodiments, pre-processing includes, but is not limited to, performing short-time Fourier transform (STFT) analysis on the audio data, mel-frequency warping to decrease the dimensions of input feature vectors of the audio data, or the like. In one or more embodiments, if the selected model is being executed by the electronic device 120A, the pre-processing of the audio data is performed by the electronic device 120A or the audio device 100A.

In embodiments in which the pre-processing is performed by the electronic device 120A, the audio data is transmitted by the audio device 100A (the controller 114C) to the electronic device 120A via the communication link 103. Then the audio data is pre-processed by the electronic device 120A (the audio generation software application 109A).

On the other hand, in one or more embodiments, if selected model is being executed by the electronic device 120A, the pre-processing may be still be performed by the audio device 100A. The audio data may be pre-processed by the controller 114C executing the program 119A. Then, the pre-processed data is transmitted by the controller 114C (the audio device 100A) to the electronic device 120A

If the selected model is being executed by, the audio device 100A, the audio device 100A performs the pre-processing of the audio data, but does not transmit the pre-processed audio to the electronic device 120A. The pre-processing of the audio data includes, but is not limited to, fine tuning and performing general noise suppression activities on the audio data, which is also referred to as denoising. The pre-processing of the audio data includes, but is not limited to, fine tuning and performing general noise suppression activities (e.g., non-peripheral device specific noise suppression activities) on the audio data, which is also referred to herein as a denoising.

At operation 312 of the method 300, the noise generated by the peripheral device 111 is at least partially removed (i.e., suppressed) from the pre-processed audio data to form denoised audio data. In one or more embodiments, suppressing the noise generated by the peripheral device 111 includes the controller associated with the device that is going to execute the selected model applies and executes the selected model. If the communication data includes an indication of the selected model, the controller associated with the device fetches the model from memory. If the communication data includes the selected model itself, the controller associated with the device executes the received model. In one or more embodiments, selected model, when executed, suppresses the noise generated by the peripheral device 111 by removing an attribute of the noise generated by the peripheral device 111 from the audio data such as the clicking sound from a keyboard.

If the audio device 100A is performing the denoising of the audio data (i.e., denoising is performed by the same device in which the algorithm 107 is located), the controller 114C fetches the selected model from the memory 113C and then applies and executes the received selected model.

If the electronic device 120A is performing the denoising of the audio data, the controller 114A, based on the received communication data from the audio device 100A, applies and executes the selected model. If the communication data includes the selected model, the controller 114A applies and executes the received selected model. If the communication data includes an indication of the selected model, the controller 114A fetches the selected model from the memory 113A and then applies and executes the received selected model.

At operation 314 of the method 300, post-processing is performed on the denoised audio data, forming post-processed audio data. The post-processing of the audio data includes, but is not limited to, formatting the denoised audio data into post-processed audio data that can be transmitted to the electronic device 120B (a second electronic device) via the network 106, inverse STFT, automatic gain control (AGC), equalization (EQ), or the like. In embodiments, in which the noise generated by the peripheral device 111 is suppressed by the electronic device 120A, post processing on the denoised audio data is performed by the electronic device 120A (e.g., the audio generation software application 109A).

In embodiments in which the noise generated by the peripheral device 111 is suppressed by the audio device 100A, the post-processing can be performed by the audio device 100A or the electronic device 120A. In embodiments, in which the noise generated by the peripheral device 111 is suppressed by the audio device 100A and the post-processing is performed by the electronic device 120A, the denoised audio data is transmitted by the audio device 100A (e.g., the controller 114C) to the electronic device 120A (e.g., the audio generation software application 109A) and the electronic device 120A performs the post-processing on the denoised audio data.

In embodiments, in which the noise generated by the peripheral device 111 is suppressed by the audio device 100A and the post-processing is performed by the audio device 100A, post-processing is performed by the controller 114C executing the program 119A.

At operation 316 of the method 300, the post-processed audio data is transmitted to the electronic device 120B (the second electronic device) located in the second location 101B. If the electronic device 120A (e.g., the audio generation software application 109A), performs the post-processing of the audio data, the electronic device 120A (e.g., the audio generation software application 109A) transmits the processed audio data to the electronic device 120B (e.g., the audio generation software application 109B) via the network 106. In one or more embodiments, the audio generation software application 109A transmits the processed audio data to the communication software application 170 via the first communication links 130A, and then the communication software application 170 transmits the post-processed data to the audio generation software application 109B via the second communication links 130B.

On the other hand, if the audio device 100A performs the post-processing, the controller 114C transmits the post-processed data to the electronic device 120A which then transmits the post-processed data to electronic device 120B in the same manner described above.

At operation 318 of the method 300, an audible signal is transmitted to an audio output in the second location 101B. In one or more embodiments, the audio generation software application 109B receives the post-processed audio data, generates an audible signal from the post-processed audio data, and transmits the audible signal to the audio output, such as the audio output device 108 of the audio device 100B.

### Third Noise Suppression Method Example

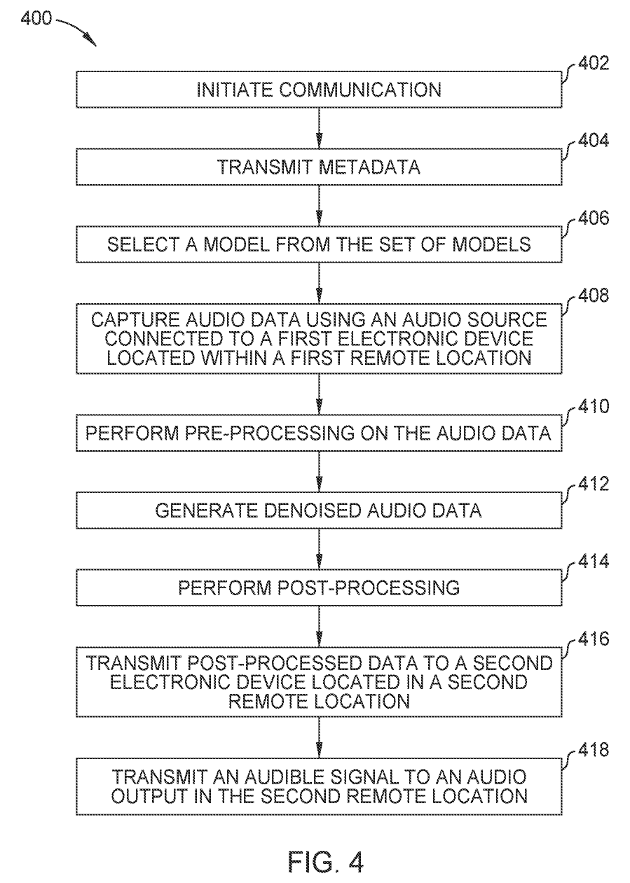

FIG. 4 illustrates a method 400 for suppressing noise generated by a peripheral device from an audible signal in the near end environment transmitted to a far end user using an algorithm located (stored) within the near end environment (e.g., first location 101A), according to one or more embodiments. FIG. 4 is described with reference to FIGS. 1A-1B. In one example, during the method 400, the algorithm 107 is stored in the audio generation software application 109A, such as in the electronic device 120A. Although the method 400 is described with respect to a single peripheral device 111 connected to the electronic device 120A, this is for example purposes only. It is understood that multiple peripheral devices can be connected to the electronic device 120A.

At operation 402 of the method 400, communication is initiated. In one or more embodiments, is a call between at least two users. In other embodiments, communication is initiated between the first user 102A that can be recorded by the audio generation software application 109A. As noted above, the call between the first two users may be performed using a communication software application 170. In addition, as noted above, the call is described from the perspective of a first user 102A, which is located in the first location 101A, on a call with the second user 102B, which is located in the second location 101B.

At operation 404 of the method 400, the algorithm 107 retrieves metadata from memory or receives metadata transmitted to it from the electronic device 120A. In one or more embodiments, the metadata is generated and transmitted to the algorithm 107 by the electronic device 120A. In another embodiment, the metadata is generated by the electronic device 120A, is stored in the memory 113A, and the algorithm accesses the metadata from the memory 113A.

Because the peripheral device 111 is connected to the electronic device 120A, the controller 114A is able to provide the metadata to the audio generation software application 109A. For example, the controller 114A is able to provide the audio generation software application 109A with information relating to the specific model number of the peripheral device 111 along with information relating to the electronic device 120A (i.e., or any other devices located in the first location 101A (the near end)). If the selected model is going to be executed by the audio device 100A, the metadata is then transmitted to the algorithm 107 by the audio generation software application 109A by use of the communication link 103.

At operation 406 of the method 400, the algorithm 107 selects a model from the sets of models based on the information contained within the metadata. As noted above, the metadata received by the algorithm 107 is indicative of the specific model number of the peripheral device 111 and/or information of the device that will execute the selected model. For example, if the peripheral device 111 is a mechanical keyboard, the metadata includes information relating to the manufacturer and model number of the keyboard. The algorithm 107 can then select a model from the set of models that correspond to a keyboard.

If the selected model is being executed on the electronic device 120A, the algorithm 107 selects a model (i.e., generates the communication data) based on, for example, information relating to the manufacturer and model number of the peripheral device 111, the processing power required to execute each model within the set of models, the battery consumption required to execute each model within the set of models, and the like versus the processing power, the memory capacity, and the battery capacity of the electronic device 120A. As noted above, the algorithm 107 can select a model corresponding to, but not limited to, a general keyboard model, any type of mechanical keyboard model, a mechanical keyboard with a specific type of switches model, or the specific model number of the peripheral device 111 model. For example, a model within the set of models might require more processing power than the available processing power of the controller 114A, and/or consume a substantial quantity of battery life (e.g., based on the battery capacity of the electronic device 120A, the remaining battery, and/or if the electronic device is in power saving mode). Stated otherwise, in some embodiments, the algorithm 107 selects the most specific model that is within at least the processing capabilities of the controller 114A and battery capacity (and requirements) of the electronic device 120A.

On the other hand, if the selected model is being executed on the audio device 100A, as noted above, the algorithm 107 selects the model (i.e., generates the communication data) based on the information relating to manufacturer and model number of the peripheral device 111, the processing power required to execute each model within the set of models, the memory consumed by each model, the battery consumption required to execute each model within the set of models, and the like versus the processing power, memory capacity, and battery capacity of the audio device 100A. For example, a model within the set of models might require more processing power than the processing power of the controller 114C, more memory than what is available in the memory 113C, and/or consume a substantial quantity of battery (e.g., based on the battery capacity of the audio device 100A, the remaining battery, and/or if the audio device 100A is in power saving mode). Stated otherwise, in some embodiments, the algorithm 107 selects the most specific model that is within at least the processing capabilities of the controller 114C, the memory capacity of the memory 113C, and battery capacity (and requirements) of the audio device 100A. Then the selected model is transmitted by the electronic device 120A (the audio generation software application 109A) to the audio device 100A (the memory 113C).

At operation 408 of the method 400, audio data that is generated in the first location 101A is captured using an audio system connected to the electronic device 120A (a first electronic device) located in the first location 101A. In one or more embodiments, the audio system includes the one or more microphones 117 or the one or more microphones 105 of the audio device 100A.

At operation 410 of the method 400, pre-processing is performed on the audio data to generate pre-processed audio data. In one or more embodiments, if the selected model is being executed by the electronic device 120A, the pre-processing of the audio data is performed by the electronic device 120A or the audio device 100A.

In embodiments in which the pre-processing is performed by the electronic device 120A, the audio data is transmitted by the audio device 100A (the controller 114C) to the electronic device 120A via the communication link 103. Then the audio data is pre-processed by the electronic device 120A (the audio generation software application 109A).

On the other hand, in one or more embodiments, if selected model is being executed by the electronic device 120A, the pre-processing may be still be performed by the audio device 100A. The audio data may be pre-processed by the controller 114C executing the program 119A. Then, the pre-processed data is transmitted by the controller 114C (the audio device 100A) to the electronic device 120A.

Furthermore, if the selected model is transmitted to, and will be executed by, the audio device 100A, the audio device 100A performs the pre-processing of the audio data, but does not transmit the pre-processed audio to the electronic device 120A. The pre-processing of the audio data includes, but is not limited to, fine tuning and performing general noise suppression activities on the audio data, which is also referred to as denoising.

At operation 412 of the method 400, the noise generated by the peripheral device 111 is at least partially removed (i.e., suppressed) from the pre-processed audio data to form denoised audio data. In one or more embodiments, as noted above, suppressing the noise generated by the peripheral device 111 includes applying and executing the selected model by the audio device 100A or the electronic device 120A. In one or more embodiments, selected model, when executed, suppresses the noise generated by the peripheral device 111 by removing an attribute of the noise generated by the peripheral device 111 from the audio data such as the clicking sound from a keyboard.

If the electronic device 120A is performing the denoising of the audio data (i.e., denoising is performed by the same device in which the algorithm 107 is located), the controller 114A fetches the selected model from the memory 113A and then applies and executes the received selected model.

If the audio device 100A is performing the denoising of the audio data, the controller 114C, based on the received communication data from the electronic device 120A, applies and executes the selected model. If the communication data includes the selected model, the controller 114C applies and executes the received selected model. If the communication data includes an indication of the selected model, the controller 114C fetches the selected model from the memory 113C and then applies and executes the received selected model.

At operation 414 of the method 400, post-processing is performed on the denoised audio data, forming post-processed processed audio data. In embodiments, in which the noise generated by the peripheral device 111 is suppressed by the electronic device 120A, post processing on the denoised audio data is performed by the electronic device 120A (e.g., the audio generation software application 109A).

In embodiments in which the noise generated by the peripheral device 111 is suppressed by the audio device 100A, the post-processing can be performed by the audio device 100A or the electronic device 120A. In embodiments, in which the noise generated by the peripheral device 111 is suppressed by the audio device 100A and the post-processing is performed by the electronic device 120A, the denoised audio data is transmitted by the audio device 100A (e.g., the controller 114C) to the electronic device 120A (e.g., the audio generation software application 109A) and the electronic device 120A performs the post-processing on the denoised audio data.

In embodiments, in which the noise generated by the peripheral device 111 is suppressed by the audio device 100A and the post-processing is performed by the audio device 100A, post-processing is performed by the controller 114C executing the program 119A. The post-processing of the audio data includes, but is not limited to, formatting the denoised audio data into post-processed audio data that can be transmitted to the electronic device 120B (a second electronic device) via the network 106.

At operation 416 of the method 400, the post-processed audio data is transmitted to the electronic device 120B (the second electronic device) located in the second location 101B. If the electronic device 120A (e.g., the audio generation software application 109A), performs the post-processing of the audio data, the electronic device 120A (e.g., the audio generation software application 109A) transmits the processed audio data to the electronic device 120B (e.g., the audio generation software application 109B) via the network 106. In one or more embodiments, the audio generation software application 109A transmits the processed audio data to the communication software application 170 via the first communication links 130A, and then the communication software application 170 transmits the post-processed data to the audio generation software application 109B via the second communication links 130B.

On the other hand, if the audio device 100A performs the post-processing, the controller 114C transmits the post-processed data to the electronic device 120A which then transmits the post-processed data to electronic device 120B in the same manner described above.

At operation 418 of the method 400, an audible signal is transmitted to an audio output in the second location 101B. In one or more embodiments, the audio generation software application 109B receives the post-processed audio data, generates an audible signal from the post-processed audio data, and transmits the audible signal to the audio output, such as the audio output device 108 of the audio device 100B.

On the other hand, in operation 412, the selected model can be executed in both the electronic device 120A and the audio device 100A. For example, in operation 306, the selected model can be transmitted to the audio device 100A, in operation 310 the pre-processing of the audio data can be performed by the audio device 100A, in operation 312 the selected model can be partially executed by the audio device 100A and the electronic device 120B, and in operation 314 the denoised audio data is post-processed by the audio device 100B.

### Fourth Noise Suppression Method Example

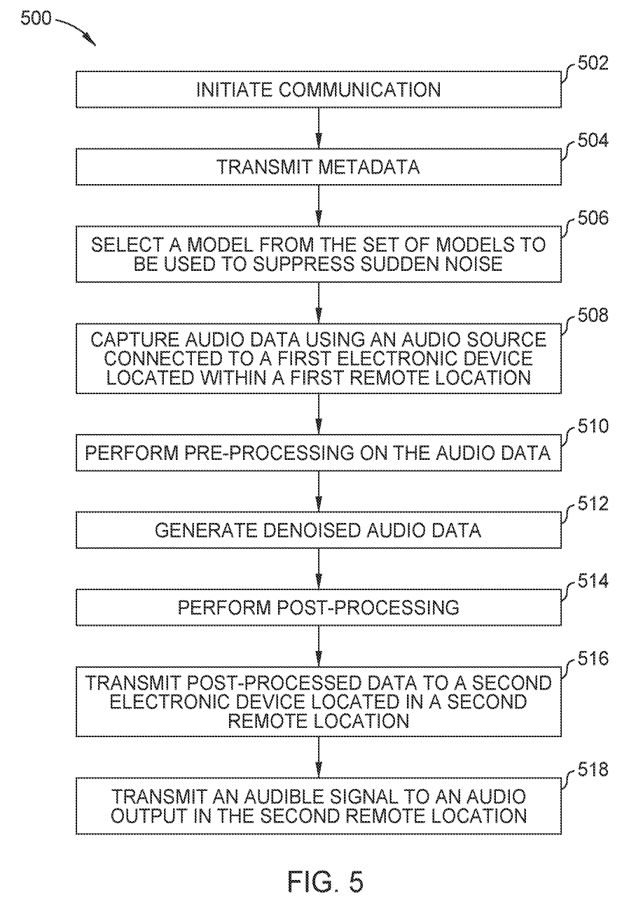

FIG. 5 illustrates a method 500 for suppressing noise generated by a peripheral device from an audible signal transmitted to a far end user using an algorithm located in the network 106, according to one or more embodiments. FIG. 4 is described with reference to FIGS. 1A-1B. In one or more embodiments, during the method 400, the algorithm 107 is stored in the memory 113E of the communication software application 170. Although the method 400 is described with respect to a single peripheral device 111 connected to the electronic device 120A (a first electronic device), this is for example purposes only. It is understood that multiple peripheral devices can be connected to the electronic device 120A.

At operation 502 of the method 500, communication is initiated. In one or more embodiments, is a call between at least two users. In other embodiments, communication is initiated between the first user 102A that can be recorded by the audio generation software application 109A. As noted above, the call between the first two users may be performed using a communication software application 170. In addition, as noted above, the call is described from the perspective of a first user 102A, which is located in the first location 101A, on a call with the second user 102B, which is located in the second location 101B.

At operation 504 of the method 500, the algorithm 107 retrieves metadata from memory or receives metadata transmitted to it from the electronic device 120A. In one or more embodiments, the metadata is generated and transmitted to the algorithm 107 by the electronic device 120A. In another embodiment, the metadata is generated by the electronic device 120A, is stored in the memory 113A, and the algorithm accesses the metadata from the memory 113A. The metadata is used to inform the algorithm 107 of the type and/or model number of the peripheral device 111 that is connected to the electronic device 120A located within the first location 101A and inform the algorithm 107 of the device that will execute the selected model.

Because the peripheral device 111 is connected to the electronic device 120A, the controller 114A is able to provide information regarding a specific model number(s) of the peripheral device(s) in communication with the electronic device 120A to the audio generation software application 109A. For example, the controller 114A is able to provide the audio generation software application 109A with information relating to the specific model number of the peripheral device 111 along with information relating to the electronic device 120A and/or the audio device 100A. The metadata is then transmitted to the algorithm 107 by the audio generation software application 109A by use of the first communication links 130A.

At operation 506 of the method 500, the algorithm 107 selects a model from the sets of models based on the information contained within the metadata. As noted above, the metadata received by the algorithm 107 is includes information relating to of the specific model number of the peripheral device 111 and/or information of the device that will execute the selected model. As will be described in more detail below, the selected model may be executed by the audio device 100A, the electronic device 120A, the communication software application 170, or combinations thereof.

If the selected model is being executed on the audio device 100A, as noted above, the algorithm 107 can select the model (generate the communication information) based on the manufacturer and model number of the peripheral device, the processing power required to execute each model within the set of models, the memory consumed by each model, the battery consumption required to execute each model within the set of models, and the like versus the processing power, memory capacity, and battery capacity the audio device 100A. For example, a model within the set of models might require more processing power than the processing power of the controller 114C, more memory than what is available in the memory 133C, and/or consume a substantial quantity of battery (e.g., based on the battery capacity of the audio device 100A, the remaining battery, and/or if the audio device 100A is in power saving mode). Stated otherwise, in some embodiments, the algorithm 107 selects the most specific model that is within at least the processing capabilities of the controller 114C, the memory capacity of the memory 113C, and battery capacity (and requirements) of the audio device 100A. The communication data is transmitted by the network 106 (e.g., the communication software application 170) to the electronic device 120A (e.g., the audio generation software application 109A) via the first communication links 130A. Then the communication data is transmitted by the electronic device 120A (e.g., the audio generation software application 109A) to the audio device 100A (e.g., the memory 113C).

In one or more embodiments, if the selected model is being executed on the electronic device 120A, the algorithm 107 selects the model based on information relating to the manufacturer and model number of the peripheral device 111, the processing power required to execute each model within the set of models, the memory consumed by each model, the battery consumption required to execute each model within the set of models, and the like, versus the processing power, memory capacity and battery capacity of the electronic device 120A. For example, a model within the set of models might require more processing power than the processing power of the controller 114A, more memory than what is available in the memory 113A, and/or consume a substantial quantity of battery (e.g., based on the battery capacity of the electronic device 120A, the remaining battery, and/or if the electronic device 120A is in power saving mode). Stated otherwise, in some embodiments, the algorithm 107 selects the most specific model that is within at least the processing capabilities of the controller 114A, the memory capacity of the memory 113A, and battery capacity (and requirements) of the electronic device 120A. Then the communication data is transmitted by the network 106 (e.g., the communication software application 170) to the electronic device 120A (e.g., the audio generation software application 109A) via the first communication links 130A.

In one or more embodiments, if the selected model is executed on the communication software application 170, as noted above, the algorithm 107 selects the model based on the manufacturer and model number of the peripheral device 111, the processing power required to execute each model within the set of models versus the processing power of the server 114E.

At operation 508 of the method 500, audio data that is generated in the first location 101A is captured using an audio system connected to the electronic device 120A located in the first location 101A. In one or more embodiments, the audio system includes the one or more microphones 117 or the one or more microphones 105 of the audio device 100A.

At operation 510 of the method 400, pre-processing is performed on the audio data to generate pre-processed audio data. In one or more embodiments, if the selected model is being executed by the electronic device 120A, the pre-processing of the audio data is performed by the electronic device 120A or the audio device 100A.

In embodiments in which the pre-processing is performed by the electronic device 120A, the audio data is transmitted by the audio device 100A (the controller 114C) to the electronic device 120A via the communication link 103. Then the audio data is pre-processed by the electronic device 120A (audio generation software application 109A).

In one or more embodiments, if selected model is being executed by the electronic device 120A, the pre-processing may be still be performed by the audio device 100A. The audio data may be pre-processed by the controller 114C executing the program 119A. Then, the pre-processed data is transmitted by the controller 114C (the audio device 100A) to the electronic device 120A.

If the selected model is transmitted to (and will be executed by) the audio device 100A, the audio device 100A performs the pre-processing of the audio data, but does not provide the pre-processed audio the electronic device 120A.

If the selected model is being executed by the communication software application 170, pre-processing may be performed by the audio device 100A or the electronic device 120A in the manner described above. The pre-processing of the audio data includes, but is not limited to, fine tuning and performing general noise suppression activities (e.g., non-peripheral device specific noise suppression activities) on the audio data which is also referred to herein as denoising.

At operation 512 of the method 500, the noise generated by the peripheral device 111 is at least partially removed (i.e., suppressed) from the pre-processed audio data, to form denoised audio data. In one or more embodiments, as noted above, the noise generated by the peripheral device 111 is suppressed (i.e., the selected model may be executed by) by the audio device 100A, the electronic device 120A, the network 106, or combinations thereof. In one or more embodiments, selected model, when executed, suppresses the noise generated by the peripheral device 111 by removing an attribute of the noise generated by the peripheral device 111 from the audio data such as the clicking sound from a keyboard.

If the electronic device 120A is performing the denoising of the audio data, the controller 114A the electronic device applies and executes the selected model based on the received communication data from the network 106. If the communication data includes the selected model, the controller 114A applies and executes the received selected model. If the communication data includes an indication of the selected model, the controller 114A fetches the selected model from the memory 113A and then applies and executes the received selected model.

If the audio device 100A is performing the denoising of the audio data, the controller 114C the electronic device applies and executes the selected model based on the received communication data from the network 106. If the communication data includes the selected model, the controller 114C applies and executes the received selected model. If the communication data includes an indication of the selected model, the controller 114C fetches the selected model from the memory 113C and then applies and executes the received selected model.

In embodiments in which the communication software application 170 executes the selected model, (e.g., performs the denoising of the noise generated by the peripheral device 111) suppressing the noise generated by the peripheral device 111 includes the server 114E executing the selected model.

At operation 514 of the method 500, post-processing is performed on the denoised audio data forming post-processed processed audio data. In embodiments, in which the noise generated by the peripheral device 111 is suppressed by the electronic device 120A, post processing on the denoised audio data is performed by the electronic device 120A (e.g., the audio generation software application 109A).

In embodiments in which the noise generated by the peripheral device 111 is suppressed by the audio device 100A and/or the network 106 (the communication software application 170), the post-processing can be performed by the audio device 100A or the electronic device 120A. In embodiments, in which the noise generated by the peripheral device 111 is suppressed by the audio device 100A and the post-processing is performed by the electronic device 120A, the denoised audio data is transmitted by the audio device 100A (e.g., the controller 114C) to the electronic device 120A (e.g., the audio generation software application 109A) and the electronic device 120A performs the post-processing on the denoised audio data.

In embodiments in which the noise generated by the peripheral device 111 is suppressed by the audio device 100A and the post-processing is performed by the audio device 100A, the post-processing is performed by the controller 114C which can include the controller 114C executing the program 119A. The post-processing of the audio data includes, but is not limited to, formatting the denoised audio data into post-processed audio data that can be transmitted to the electronic device 120B (a second electronic device) via the network 106.

Alternatively, in embodiments in which the selected model is executed by the communication software application 170, the audio data is post-processed, forming post-processed audio data prior to suppressing the noise generated by the peripheral device 111. Stated differently, operation 414 is performed before operation 412. At operation 414 the post-processed data is generated and transmitted to the communication software application 170, and then at operation 412 the communication software application 170 suppresses the noise generated from the peripheral device 111 be executing the selected model.

At operation 516 of the method 500, the post-processed audio data is transmitted to the electronic device 120B (the second electronic device) located in the second location 101B.

At operation 518 of the method 500, an audible signal is transmitted to an audio output in the second location 101B. In one or more embodiments, the audio generation software application 109B receives the post-processed audio data, generates an audible signal from the post-processed audio data, and transmits the audible signal to the audio output such as the audio output device 108 of the audio device 100B.

### Fifth Noise Suppression Method Example

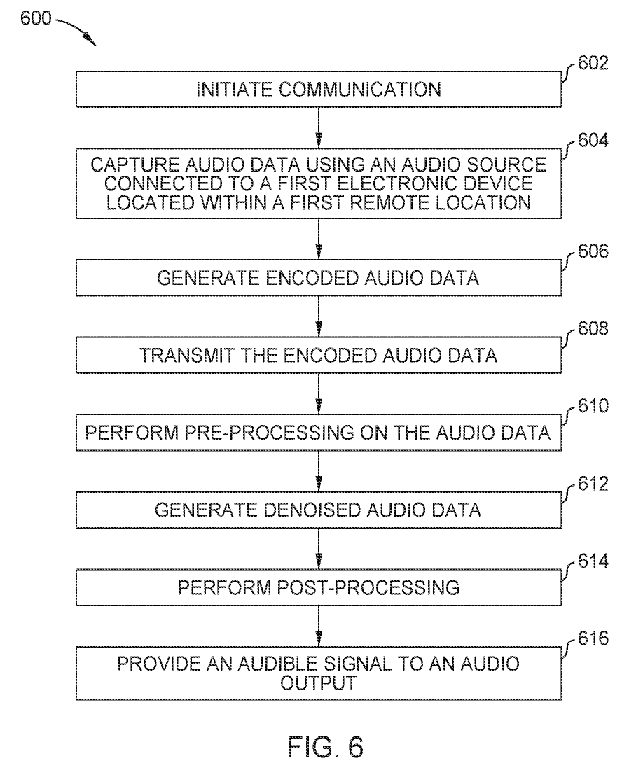

FIG. 6 illustrates a method 600 for suppressing noise generated by a peripheral device from an audible signal transmitted to a far end user using an algorithm located (stored) within the far end environment (e.g., second location 101B), according to one or more embodiments. FIG. 6 is described with reference to FIGS. 1A-1B. In one or more embodiments, during the method 600, the algorithm 107 is stored in the memory 113D (e.g., in the audio device 100B). Although the method 500 is described with respect to a single peripheral device 111 connected to the electronic device 120A, this is for example purposes only. It is understood that multiple peripheral devices can be connected to the electronic device 120A.

At operation 602 of the method 600, communication is initiated. In one or more embodiments, is a call between at least two users. In other embodiments, communication is initiated between the first user 102A that can be recorded by the audio generation software application 109A. As noted above, the call between the first two users may be performed using a communication software application 170. In addition, as noted above, the call is described from the perspective of a first user 102A, which is located in the first location 101A, on a call with the second user 102B, which is located in the second location 101B.

At operation 604 of the method 600, audio data generated in the first location 101A is captured using an audio system connected to the electronic device 120A (a first electronic device) located in the first location 101A. In one or more embodiments, the audio data is captured by the one or more microphones 105 of the audio device 100A or the one or more microphones 117A. Then the audio data is transmitted by the audio device 100A (e.g., the controller 114C) to the electronic device 120A (e.g., the audio generation software application 109A) via the communication link 103.

At operation 606 of the method 600, the electronic device 120A generates encoded audio data. As described above, the audio generation software application 109A is able to receive the metadata from the controller 114A. In one or more embodiments, the audio generation software application 109A encodes (i.e., watermarks) the audio data with the metadata forming encoded audio data. In other embodiments, the metadata is transmitted to the algorithm 107 separately by the audio generation software application 109A via a sideband link. In one or more embodiments, the electronic device 120A also formats the encoded audio data (e.g., performs pre-processing on the encoded audio data) so that the encoded audio data can be transmitted to the second electronic device (e.g., electronic device 120B) using the network 106.

At operation 608 of the method 600, the encoded audio data is transmitted to the electronic device 120B (the second electronic device) which is located in the second location 101B. The audio generation software application 109A transmits the encoded audio data to the communication software application 170 via the first communication links 130A, and then the communication software application 170 transmits the encoded audio data to the audio generation software application 109B via the second communication links 130B.

At operation 610 of the method 500, pre-processing is performed on the encoded audio data to generate pre-processed audio data. In one or more embodiments, if the selected model is being executed by the electronic device 120B, the pre-processing of the audio data is performed by the electronic device 120B (e.g., the audio generation software application 109B).

On the other hand, in one or more embodiments, if selected model is being executed by the audio device 100B, the pre-processing may be still be performed by electronic device 120B. However, after the pre-processing is complete, the pre-processed data is transmitted to the audio device 100B. Alternatively, if the selected model is to be executed on the audio device 100B, the encoded audio data may be transmitted to the audio device 100B from the electronic device 120B and the pre-processing may be performed on the audio device 100B (the controller 114C executing the program 119B).

At operation 612 of the method 600, the noise generated by the peripheral device 111 is at least partially removed (i.e., suppressed) from the pre-processed audio data, to form denoised audio data. In one or more embodiments, suppressing the noise generated by the peripheral device 111 includes applying and executing the selected model. In one or more embodiments, the selected model, when executed, suppresses the noise generated by the peripheral device 111 by removing an attribute of the noise generated by the peripheral device 111 from the audio data, such as the clicking sound from a keyboard.

If the audio device 100B is performing the denoising of the audio data (i.e., denoising is performed by the same device in which the algorithm 107 is located), the server 114E fetches the selected model from the memory 113E and then applies and executes the received selected model.

If the electronic device 120B is performing the denoising of the audio data, the controller 114A, based on the received communication data from the audio device 100B, applies and executes the selected model. If the communication data includes the selected model, the controller 114B applies and executes the received selected model. If the communication data includes an indication of the selected model, the controller 114B fetches the selected model from the memory 113B and then applies and executes the received selected model.

At operation 614 of the method 600, post-processing is performed on the denoised audio data, forming an audible signal. In embodiments, in which the noise generated by the peripheral device 111 is suppressed by the electronic device 120B, post-processing on the denoised audio data can be performed by the electronic device 120B (e.g., the audio generation software application 109B) or the audio device 100B.

In embodiments, in which the noise generated by the peripheral device 111 is suppressed by the electronic device 120B and the post-processing is performed by the audio device 100B, the denoised audio data is transmitted by the electronic device 120B (e.g., the controller 114B) to the audio device 100B (e.g., the memory 113D) and the controller 114D generates the audible signal.

In embodiments, in which the noise generated by the peripheral device 111 is suppressed by the electronic device 120B and the post-processing is performed by the electronic device 120B, the electronic device 120B generates the audible signal.

At operation 616 of the method 600, the audible signal is transmitted to an audio output in the second location 101B. In embodiments, in which the noise generated by the peripheral device 111 is suppressed by the electronic device 120B, post-processing on the denoised audio data can be performed by the electronic device 120B (e.g., the audio generation software application 109B) or the audio device 100B.

In embodiments, in which the noise generated by the peripheral device 111 is suppressed by the electronic device 120B and the post-processing is performed by the audio device 100B, the denoised audio data is transmitted by the electronic device 120B (e.g., the controller 114B) to the audio device 100B (e.g., the memory 113D) and the controller 114D generates the audible signal.

In embodiments, in which the noise generated by the peripheral device 111 is suppressed by the electronic device 120B and the post-processing is performed by the electronic device 120B, the electronic device 120B generates the audible signal.

### Sixth Noise Suppression Method Example

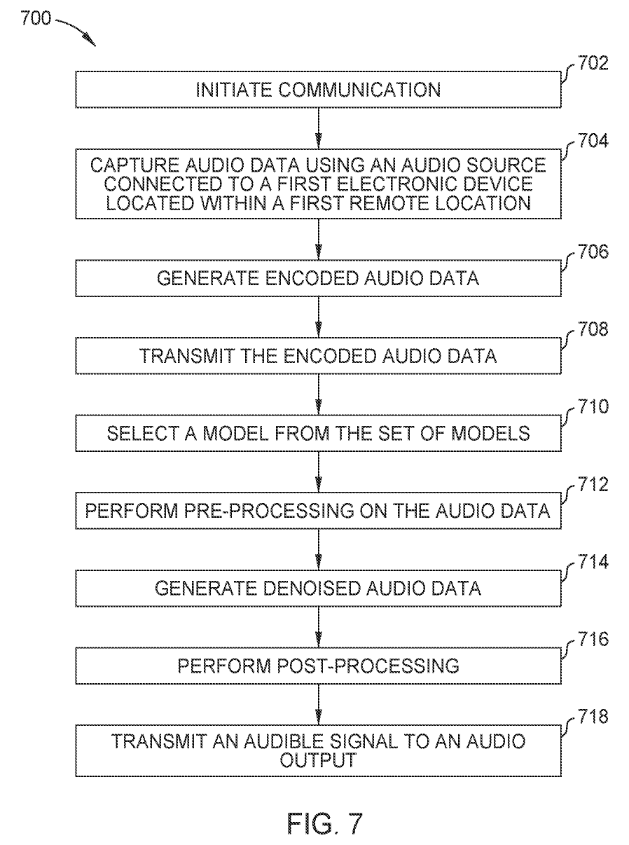

FIG. 7 illustrates a method 700 for suppressing noise generated by a peripheral device from an audible signal transmitted to a far end user using an algorithm located (stored) in the far end, according to one or more embodiments. FIG. 7 is described with reference to FIGS. 1A-1B. In one or more examples, during the method 600, the algorithm 107 is stored in the memory 113B (e.g., in the electronic device 120B). Although the method 700 is described with respect to a single peripheral device 111 connected to the electronic device 120A (first electronic device), this is for example purposes only. It is understood that multiple peripheral devices can be connected to the electronic device 120A.

At operation 702 of the method 700, communication is initiated. In one or more embodiments, is a call between at least two users. In other embodiments, communication is initiated between the first user 102A that can be recorded by the audio generation software application 109A. As noted above, the call between the first two users may be performed using a communication software application 170. In addition, as noted above, the call is described from the perspective of a first user 102A, which is located in the first location 101A, on a call with the second user 102B, which is located in the second location 101B.

At operation 704 of the method 700, audio data generated in the first location 101A is captured using an audio system connected to the electronic device 120A (a first electronic device) located in the first location 101A. In one or more embodiments, the audio data is captured by the one or more microphones 105 of the audio device 100A or the one or more microphones 117A. Then the audio data is transmitted by the audio device 100A (the controller 114C) to the electronic device 120A (the audio generation software application 109A) via the communication link 103.

At operation 706 of the method 700, the electronic device 120A generates encoded audio data. As described above, the audio generation software application 109A is able to receive metadata from the controller 114A. In one or more embodiments, the audio generation software application 109A encodes (i.e., watermarks) the audio data with the metadata forming encoded audio data. In other embodiments, the metadata is transmitted to the algorithm 107 separately by the audio generation software application 109A via a sideband link. In one or more embodiments, the electronic device 120A or the audio device 100A also formats the encoded audio data (performs pre-processing on the encoded audio data in the same manner described above) so that the encoded audio data can be transmitted to a second electronic device (electronic device 120B) using the network 106.

At operation 708 of the method 700, the encoded audio data is transmitted to the electronic device 120B (the second electronic device) located in the second location 101B. The audio generation software application 109A transmits the encoded audio data to the communication software application 170 via the first communication links 130A, and then the communication software application 170 transmits the encoded audio data to the audio generation software application 109B via the second communication links 130B.

At operation 710 of the method 700, the algorithm 107 selects a model from the sets of models based on the information contained within the metadata.

In one or more embodiments, the algorithm 107 selects a model that is to be executed by the electronic device 120B. If the selected model is being executed on the electronic device 120B, the algorithm 107 selects a model based on the manufacturer and model number of the peripheral device, the processing power required to execute each model within the set of models, the battery consumption required to execute each model within the set of models, and the like versus the processing power, the memory capacity and the battery capacity of the electronic device 120B. As noted above, the algorithm 107 can select a model corresponding to, but not limited to, a general keyboard model, any type of mechanical keyboard model, a mechanical keyboard model with a specific type of switches, or the specific model keyboard of the peripheral device 111. For example, a model within the set of models might require more processing power than the available processing power of the controller 114B, and/or consume a substantial quantity of battery (e.g., based on the battery capacity of the electronic device 120B, the remaining battery, and/or if the electronic device is in power saving mode). Stated otherwise, in some embodiments, the algorithm 107 selects the most specific model that is within at least the processing capabilities of the controller 114B and battery capacity (and requirements) of the electronic device 120B.

If the selected model is being executed on the audio device 100B, as noted above, the algorithm 107 can select the model based on information relating to the manufacturer and model number of the peripheral device 111, the processing power required to execute each model within the set of models, the memory consumed by each model, the battery consumption required to execute each model within the set of models, and the like versus the processing power, memory capacity, and battery capacity of the audio device 100B. For example, a model within the set of models might require more processing power than the processing power of the controller 114D, more memory than what is available in the memory 113D, and/or consume a substantial quantity of battery (e.g., based on the battery capacity of the audio device 100A, the remaining battery, and/or if the audio device 100A is in power saving mode). Stated otherwise, in some embodiments, the algorithm 107 selects the most specific model that is within at least the processing capabilities of the controller 114D, the memory capacity of the memory 113D, and battery capacity (and requirements) of the audio device 100B. Then the communication data is transmitted by the electronic device 120B (the audio generation software application 109B) to the audio device 100B (the memory 113B).

At operation 710 of the method 700, pre-processing is performed on the encoded audio data to generate pre-processed audio data. In one or more embodiments, if the selected model is being executed by the electronic device 120B, the pre-processing of the audio data is performed by the electronic device 120B (e.g., the audio generation software application 109B).

On the other hand, in one or more embodiments, if selected model is being executed by the audio device 100B, the pre-processing may be still be performed by electronic device 120B. However, after the pre-processing is complete, the pre-processed data is transmitted to the audio device 100B. Alternatively, if the selected model is to be executed on the audio device 100B, the encoded audio data may be transmitted to the audio device 100B from the electronic device 120B and the pre-processing may be performed on the audio device 100B (the controller 114C executing the program 119B).

At operation 714 of the method 700, the noise generated by the peripheral device 111 is at least partially removed (i.e., suppressed) from the pre-processed audio data, to form denoised audio data. In one or more embodiments, as noted above, the noise generated by the peripheral device 111 is suppressed (i.e., the selected model may be executed by) by the audio device 100B or the electronic device 120B.

If the electronic device 120B is performing the denoising of the audio data (i.e., denoising is performed by the same device in which the algorithm 107 is located), the controller 114B fetches the selected model from the memory 113B and then applies and executes the received selected model.

If the audio device 100B is performing the denoising of the audio data, the controller 114D, based on the received communication data from the electronic device 120B, applies and executes the selected model. If the communication data includes the selected model, the controller 114D applies and executes the received selected model. If the communication data includes an indication of the selected model, the controller 114D fetches the selected model from the memory 113D and then applies and executes the received selected model.

At operation 716 of the method 700, post-processing is performed on the denoised audio data forming an audible signal. In embodiments, in which the noise generated by the peripheral device 111 is suppressed by the electronic device 120B, post-processing on the denoised audio data can be performed by the electronic device 120B (e.g., the audio generation software application 109B) or the audio device 100B.

In embodiments, in which the noise generated by the peripheral device 111 is suppressed by the electronic device 120B and the post-processing is performed by the audio device 100B, the denoised audio data is transmitted by the electronic device 120B (e.g., the controller 114B) to the audio device 100B (e.g., the memory 113D) and the controller 114D generates the audible signal.

In embodiments, in which the noise generated by the peripheral device 111 is suppressed by the electronic device 120B and the post-processing is performed by the electronic device 120B, the electronic device 120B generates the audible signal.

At operation 718 of the method 700, the audible signal is transmitted to an audio output in the second location 101B. If the electronic device 120B performed post-processing, the audible signal is transmitted to the audio output, such as the audio output device 108 of the audio device 100B within the second location 101B, by the electronic device 120B (e.g., the controller 114B). If the audio device 100B performed post-processing, the audible signal is transmitted to the audio output device 108 by the audio device 100B (the controller 114D).

As noted above, in one or more embodiments, the selected model can be transmitted to both the electronic device 120B and the audio device 100B and suppressing the noise generated by the peripheral device 111 can be partially performed by the electronic device 120B and the audio device 100B.

Furthermore as noted above, the algorithm and/or a selected model can be transmitted to any combination of the audio device 100A, the electronic device 120A, the communication software application 170, the electronic device 120B, and the audio device 100B, and the suppressing the noise generated by the peripheral device 111 can be partially performed by any combination thereof.

While the foregoing is directed to embodiments of the present disclosure, other and further embodiments of the disclosure may be devised without departing from the basic scope thereof, and the scope thereof is determined by the claims that follow.

What is claimed is:

1. A method comprising:
determining, by a first electronic device in a first location, that a peripheral device is present within the first location;
capturing, by an audio system within the first location, audio data;
selecting, by an algorithm, based on the determined presence of the peripheral device, a model that when executed is configured to suppress a portion of the audio data generated by the peripheral device; and
generating, by a first audio processing device, denoised audio data by suppressing at least a portion of the portion of the audio data generated by the peripheral device by executing the selected model.

2. The method of claim 1, wherein determining that the peripheral device is present within the first location by detecting that the first electronic device and the peripheral device are in communication or accessing metadata stored in memory.

3. The method of claim 1, wherein the algorithm is located in a memory of the audio system or the memory of the first electronic device.

4. The method of claim 1, wherein selecting a model further comprises selecting the model from a set of models comprising two or more models that each include audible characteristics of the peripheral device.

5. The method of claim 4, further comprising transmitting, by the first electronic device, metadata corresponding to the peripheral device to the first audio processing device.

6. The method of claim 1, wherein the first audio processing device is the first electronic device.

7. The method of claim 1, wherein the first audio processing device is the audio system.

8. The method of claim 1, wherein the algorithm is located in a second audio processing device that is different from the first audio processing device.

9. The method of claim 8, wherein the second audio processing device is at least one of: a second electronic device located in a second location, an audio device located in the second location, and a network in communication with the first electronic device and the second electronic device, wherein the second audio processing device transmits the selected model to the first audio processing device.

10. The method of claim 1, wherein the first audio processing device is a network in communication with the first electronic device and a second electronic device located in a second location.

11. The method of claim 1, wherein the audio data is transmitted by the first electronic device to a second location, and the first audio processing device is located in the second location.

12. The method of claim 1, further comprising storing the denoised audio data in a memory of the first electronic device.

13. A method comprising:
capturing, by an audio system located in a first location, audio data;
selecting, an algorithm located in the audio system, a model from a set of models that when executed is configured to suppress a portion of the audio data that is generated by a peripheral device that is located at the first location;
generating, by the audio system, denoised audio data by suppressing at last a portion of audio data generated by the peripheral device from the audio data generated in the first location by executing the selected model;
transmitting, by the audio system, the denoised audio data to a first electronic device; and
transmitting, by the first electronic device, the denoised audio data to a second electronic device located in a second location.

14. The method of claim 13, wherein the set of models comprise two or more models that each include audible characteristics of at least one peripheral device.

15. The method of claim 13, wherein the algorithm selects a model from the set of models based on metadata, wherein the metadata comprises information relating to a manufacturer or a model number that is associated with the peripheral device.

16. The method of claim 13, wherein
the peripheral device is in communication with the first electronic device located at the first location, and
the first electronic device and the second electronic device are connected via a communication software application.

17. The method of claim 13, further comprising:
generating, by the second electronic device, an audible signal based on the denoised audio data; and
providing, by the second electronic device, the audible signal to an audio device located in the second location.

18. A communication system comprising:
a first electronic device in a first location configured to determine at least one peripheral device within the first location in communication with the first electronic device;
an audio system within the first location configured to capture audio data generated within the first location; and
an algorithm configured to select, based on the at least one peripheral device in communication with the first electronic device, a model that when executed is configured to suppress an attribute of audio data generated by the at least one peripheral device; and
a first audio processing device configured to generate denoised audio data by suppressing audio generated by the at least one peripheral device from the audio data captured within the first location by executing the selected model.

19. The communication system of claim 18, wherein the algorithm is located in at least one of: the audio system, the first electronic device, a second electronic device located in a second location, a network in communication with the first electronic device and the second electronic device, and an audio device located in the second location.

20. The communication system of claim 19, wherein the algorithm is configured to select the model from a set of models comprising two or more models that each include audible characteristics of the at least one peripheral device.
